(19) United States
(12) Patent Application Publication
(10) Pub. No.: US 2018/0169933 A1
(43) Pub. Date: Jun. 21, 2018

(54) WRAP-AROUND BREAKOUT JACKET

(71) Applicant: The Zippertubing Co., Chandler, AZ (US)

(72) Inventors: Justin J. LaPorte, San Tan Valley, AZ (US); Jonathan Speirs, Gilbert, AZ (US)

(21) Appl. No.: 15/846,089

(22) Filed: Dec. 18, 2017

Related U.S. Application Data
(60) Provisional application No. 62/435,581, filed on Dec. 16, 2016.

(51) Int. Cl. B29C 61/06; F16L 57/00; B29C 61/10

(52) U.S. Cl. CPC B29C 61/0625; B29C 61/10; F16L 57/00; B29C 61/0616

(57) ABSTRACT

A wrap-around heat shrinkable protective jacket is used on conduits such as cables, pipes or tubes carrying liquids, gas or electricity to name a few. The protective jacket is applicable to junction blocks, junction tees and wire harnesses and to protect or repair damaged areas of such configurations. A lay-flat design is used to easily install around existing cables, pipes or tubes. A shrinkable material is used to secure and protect these cables, pipes or tubes. Other materials can be added to the jacket interior for additional protection.

### CROSS-REFERENCE TO RELATED APPLICATIONS

The present application claims priority benefit under 35 U.S.C. § 119(e) to U.S. Provisional Patent Application Ser. No. 62/435,581 filed Dec. 16, 2016, titled Wrap-Around Breakout Jacket. The above-referenced provisional application is hereby incorporated in its entirety by reference herein.

### BACKGROUND OF THE INVENTION

Cables, pipes and tubes are typically grouped together for routing electricity, fluids, air or other transmissive media between two locations. For example, an electrical cable typically contains a multitude of conductors for routing electrical power or electronic signals between two locations. A breakout routes a portion of these cables, pipes or tubes to a third location.

### SUMMARY OF THE INVENTION

A wrap-around jacket is used on wires, cables, pipes, tubes or other conduits when a breakout is required, such as for tees or other junctions. The jacket may protect, insulate or repair the conduits and breakout. In various embodiments, the jacket is flexible so as to fit in tight areas and is heat shrinkable.

A wrap-around breakout jacket embodiment has a lay-flat apparatus defining a first section and a second section. Fasteners are disposed on the first and second section. The first section is folded onto itself so as to form a main conduit portion. The second section is folded onto itself so as to form a breakout conduit portion. A first portion of the fasteners secure the first section in a first folded position. A second portion of the fasteners secure the second section in a second folded position.

In various embodiments the first section has a first plurality of tabs and a first plurality of tab slots. The tabs insert into the tab slots to form the main conduit portion. The second section has a jacket center section disposed between a second plurality of tabs. The second plurality of tabs fold onto and bow the jacket center section so as to form the breakout conduit portion. The first section is a generally larger square defining a plurality of main conduit wraps separated by a conduit sleeve. The second section is a generally smaller square. The first section and the second section are separated by elongated notches, and the first section and the second section fold into the elongated notches to form the main conduit portion. In an addition embodiments, the wrap-around breakout jacket conduit sleeve folds onto the second section. The second section folds around the conduit sleeve to form the breakout conduit portion. In various embodiments, the fasteners are adhesive, and the main conduit section and the breakout conduit section are heat shrinkable so as to secure a main conduit disposed through the main conduit section and a breakout conduit disposed through the breakout conduit section.

A wrap-around breakout method identifies a conduit having a main conduit and a breakout conduit, disposes a generally flexible, planar wrap proximate the conduit, defines a wrap portions. In an embodiment, a first wrap portion is disposed around the main conduit and a second wrap portion is disposed around the breakout conduit. Fasteners are located on each of the first wrap portion and second wrap portion. Heat is applied to first wrap portion and the second wrap portion to shrink fit these portions around the main conduit and the breakout conduit.

In a particular embodiment, a wrap-around jacket is a generally flat, rectangular sheet having four tabs that are defined by slots in the material. Strips of pressure-sensitive adhesive are disposed on the tabs and covered with a release liner (not shown) until use.

In various alternative embodiments, mechanical closure mechanisms such as snaps or pressure tracks may be used for securing the tabs during installation in lieu of adhesive. Tab slots provide a guide and locking mechanism during installation. Shrink direction and ratio determine the size and shape of the finished product and may change based on the application. The lay-flat design allows the wrap-around jacket to be easily positioned in tight places so as to wrap around the conduits and the breakout. Tab adhesive secures the jacket in a wrapped position. That jacket is then shrunk to fit on the conduits and the breakout using a heat gun. Various materials may be used for the exterior protective jacketing depending on the application. Other materials may be added to the jacket interior for additional protection, such as padding and heat insulation.

### BRIEF DESCRIPTION OF THE DRAWINGS

FIG. 1 is a plan view of a wrap-around breakout jacket first embodiment in an initial unwrapped position;

FIGS. 2A-B are a front plan view and a front perspective view, respectively, of a wrap-around breakout jacket first embodiment in a second wrapped position with adhesive main conduit tabs inserted through slots so as to initially form a cylindrical main conduit path;

FIG. 3 is a front isometric view of the wrap-around breakout jacket first embodiment in a third wrapped position with adhesive main conduit tabs now secured onto the main conduit path;

FIGS. 4A-B are front and back isometric views, respectively of the wrap-around breakout jacket first embodiment in a forth wrapped position with the adhesive breakout conduit tabs secured onto and bowing a middle section so as to form a narrow-elliptical breakout conduit path;

FIG. 5 is a plan view of the wrap-around breakout jacket first embodiment in an initial unwrapped position fitted underneath or behind a breakout-configured conduit assembly;

FIGS. 6A-B are perspective views of wrap-around breakout jacket first embodiment in a fully-wrapped position prior to heat shrinking and a fully-wrapped position post heat shrinking;

FIG. 7 is a plan view of a wrap-around breakout jacket second embodiment in an initial unwrapped position;

FIG. 8 is a plan view of the wrap-around breakout jacket second embodiment in an initial unwrapped position fitted underneath or behind a breakout-configured conduit assembly;

FIG. 9 is a front isometric view of the wrap-around breakout jacket second embodiment in a first wrapped position with adhesive main conduit tabs securing a main conduit wrap around a main conduit and a sleeve disposed adjacent a breakout conduit;

FIG. 10 is a front isometric view of the wrap-around breakout jacket second embodiment in a fully wrapped position prior to heat shrinking with an adhesive breakout conduit tabs securing a breakout conduit wrap around the sleeve and the breakout conduit;

FIG. 11 is a perspective view of wrap-around breakout jacket second embodiment in a fully-wrapped position after heat shrinking; and

FIG. 12 is a flow-chart generally describing a wrap-around breakout jacket apparatus and method.

### DETAILED DESCRIPTION OF THE PREFERRED EMBODIMENTS

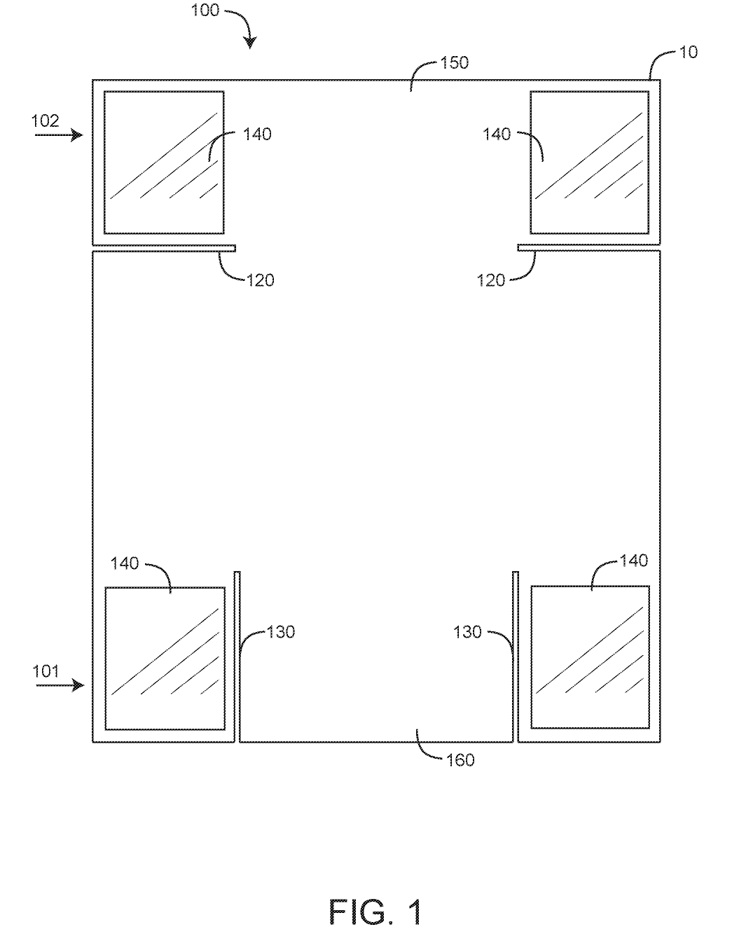

FIGS. 1-6 illustrate a wrap-around breakout jacket 10 first embodiment that is advantageously used on wires, cables, pipes, tubes or other conduits when a breakout is required, such as for junction blocks, junction tees and wire harnesses. The breakout jacket also protects, insulates or repairs these conduits, to name a few applications. In various embodiments, the breakout jacket is flexible so as to fit in tight areas and is heat shrinkable.

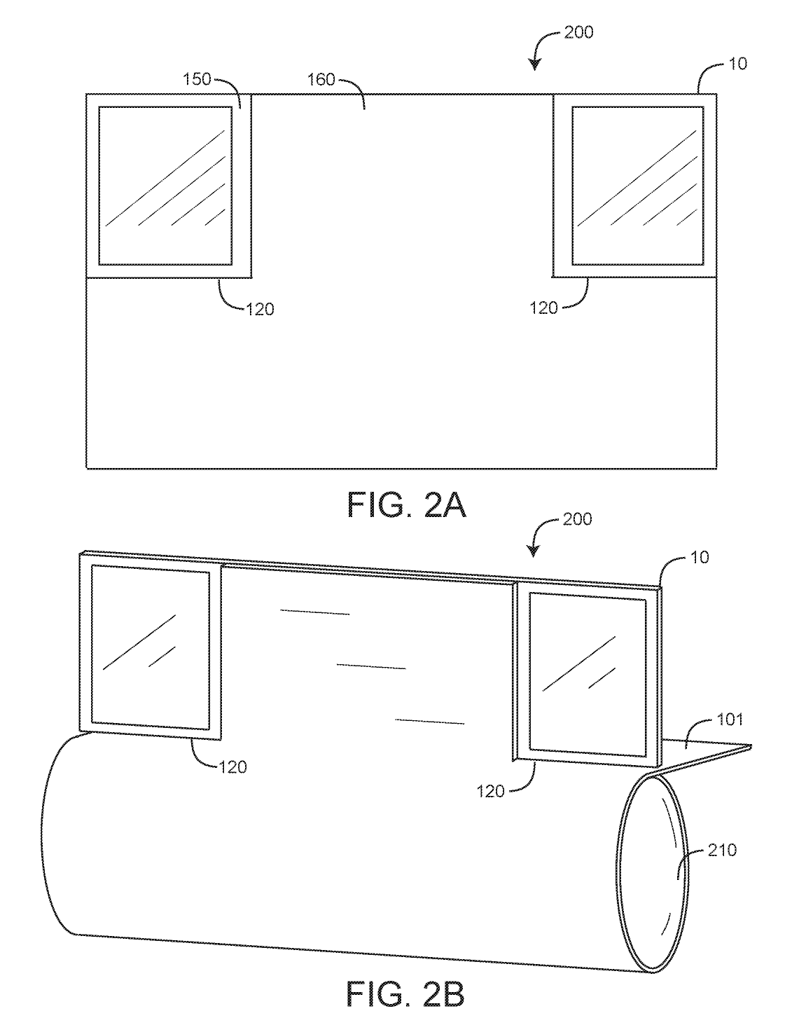

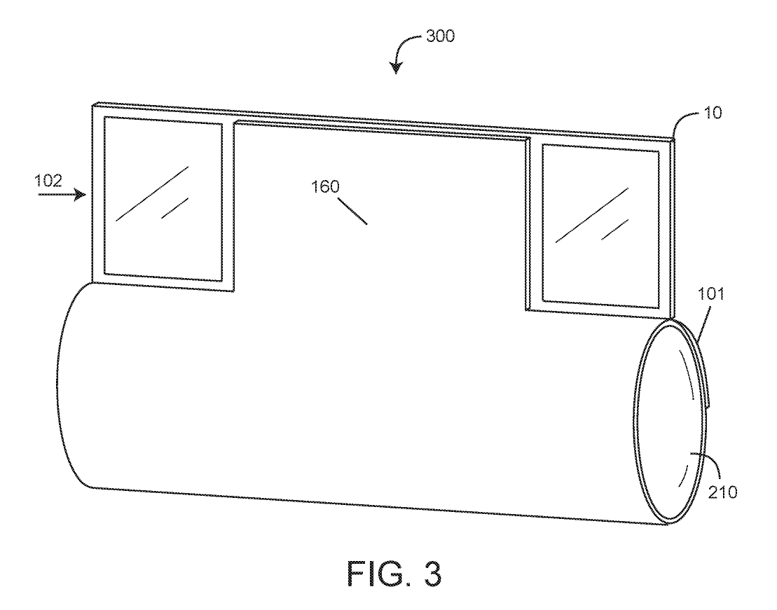

FIG. 1 illustrates a wrap-around breakout jacket 10 embodiment in an first unwrapped position 100. The breakout jacket 10 is a generally flat, rectangular sheet having four tabs 101, 102 defined by widthwise slots 120 along a top jacket portion and lengthwise slots 130 along a bottom jacket portion. Pressure sensitive adhesive (PSA) strips 140 are disposed on the tabs 101, 102 for securing the breakout jacket 10 in folded or rolled positions (FIGS. 2-3) during installation. In various embodiments, mechanical closure mechanisms such as snaps or pressure tracks are used as an alternative securing mechanisms to the PSA tabs. Tab slots 120, 130 provide a guide and locking mechanism during installation. In heat shrink applications, shrink direction and ratio determine the size and shape of the finished product and may change based upon the particular application. The initial lay-flat design allows the jacket 10 to be easily positioned in tight places so as to wrap around a breakout.

FIGS. 2-6 illustrate the detailed steps for wrapping a breakout jacket 10 around a conduit breakout installation. FIGS. 2A-B illustrate a wrap-around breakout jacket 10 in a second wrapped position 200 with adhesive main conduit tabs 101 inserted through slots 120 so as to initially form a cylindrical main conduit path 210.

FIG. 3 illustrates a wrap-around breakout jacket 10 in a third wrapped position 300 with adhesive main conduit tabs 101 now secured onto a cylindrical main conduit path 210. Further a middle section 160 abuts breakout conduit tabs 102.

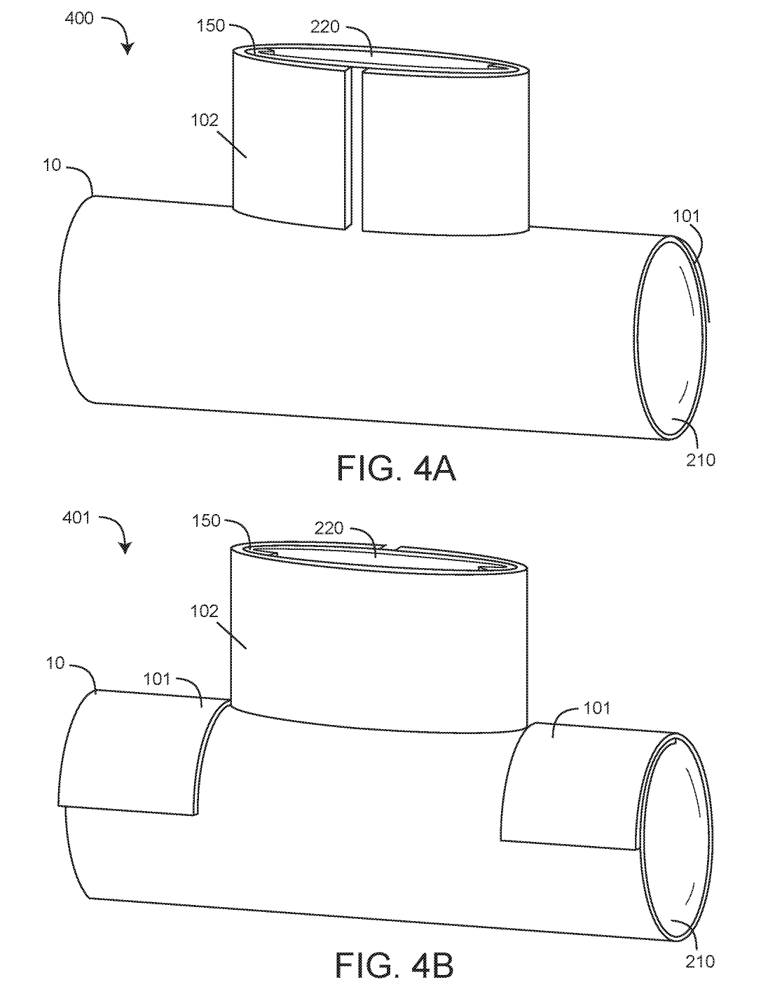

FIGS. 4A-B illustrate a wrap-around breakout jacket 10 embodiment in a fourth wrapped position 400 with the adhesive breakout conduit tabs 102 wrapped around, secured to and bowing a jacket center-edge section 150 so as to form a narrow-elliptical breakout conduit path 220.

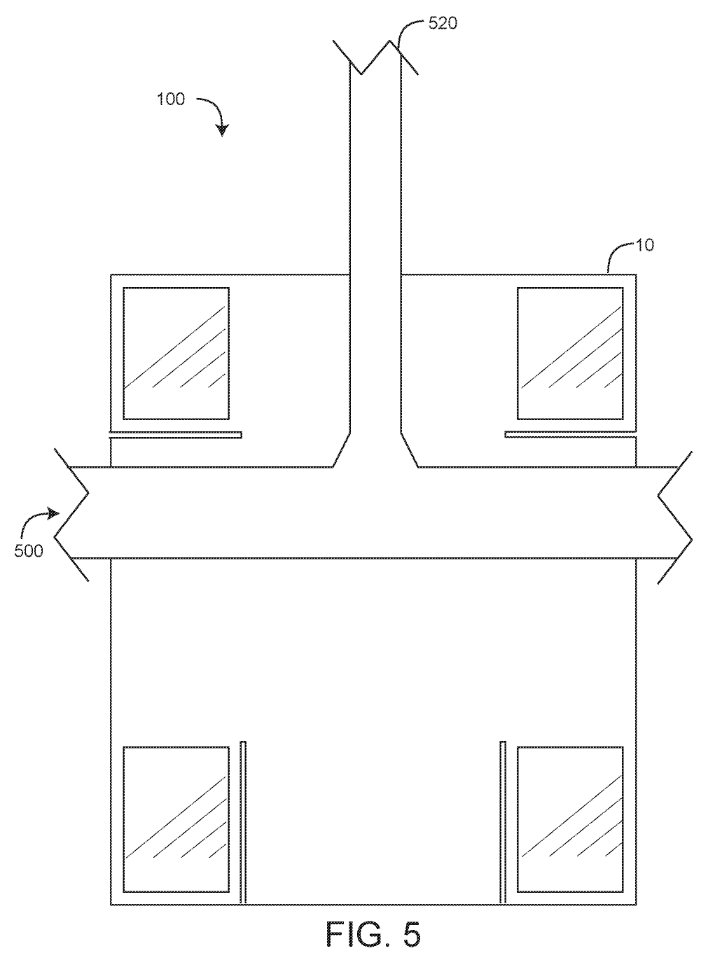

FIG. 5 illustrates a wrap-around breakout jacket 10 in an initial unwrapped position 100 fitted underneath or behind a conduit assembly 500 having a main conduit portion 510 and a breakout conduit portion 520.

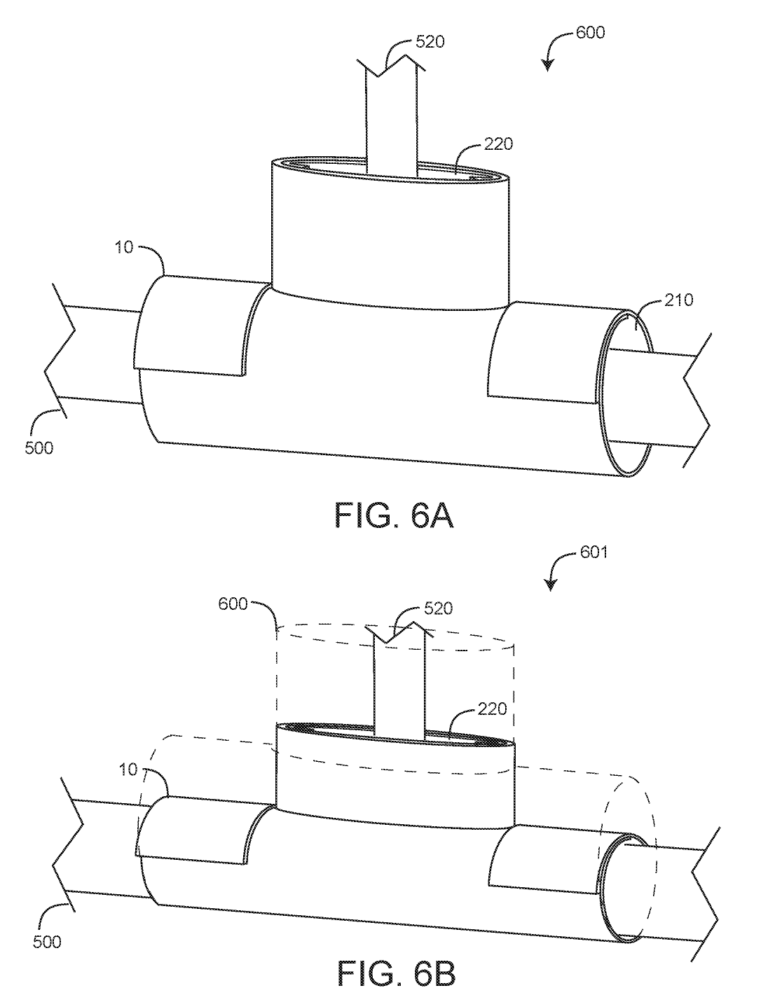

FIGS. 6A-B illustrate a wrap-around breakout jacket 10 embodiment in a final un-shrunk position 600 disposed around a conduit assembly 500 and in a final shrunk position 601 secured around a conduit assembly 500. A heat gun is used to shrink the breakout jacket 10 to achieve a desired diameter around both the main 510 and the breakout 520 conduits. Additional materials can be added to interior of the breakout jacket 10 for electrical or heat insulation, padding, EMI shielding among other applications. Additional interior materials do not affect the initial function or form of design but should be noted due to the importance of these additional applications.

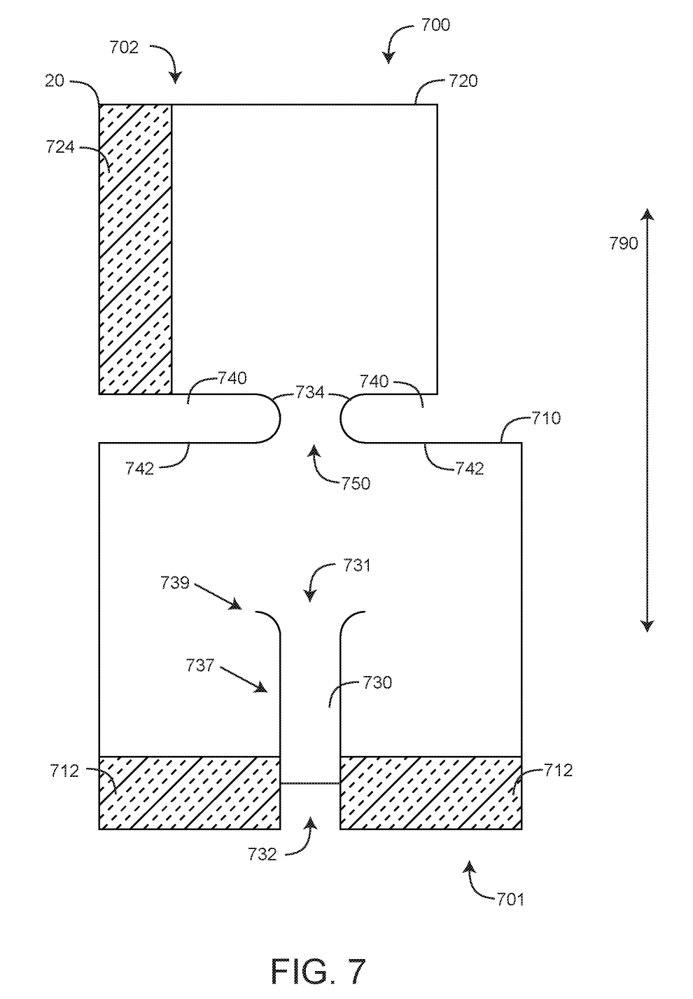

FIGS. 7-11 illustrate a second wrap-around breakout jacket 20 embodiment that is also advantageously used on wires, cables, pipes, tubes or other conduits when a breakout is required. The second breakout jacket embodiment is also flexible so as to fit in tight areas and is heat shrinkable. The second breakout jacket embodiment is further advantageously used in applications such as a junction blocks, junction tees and wire harnesses to protect or repair damaged areas.

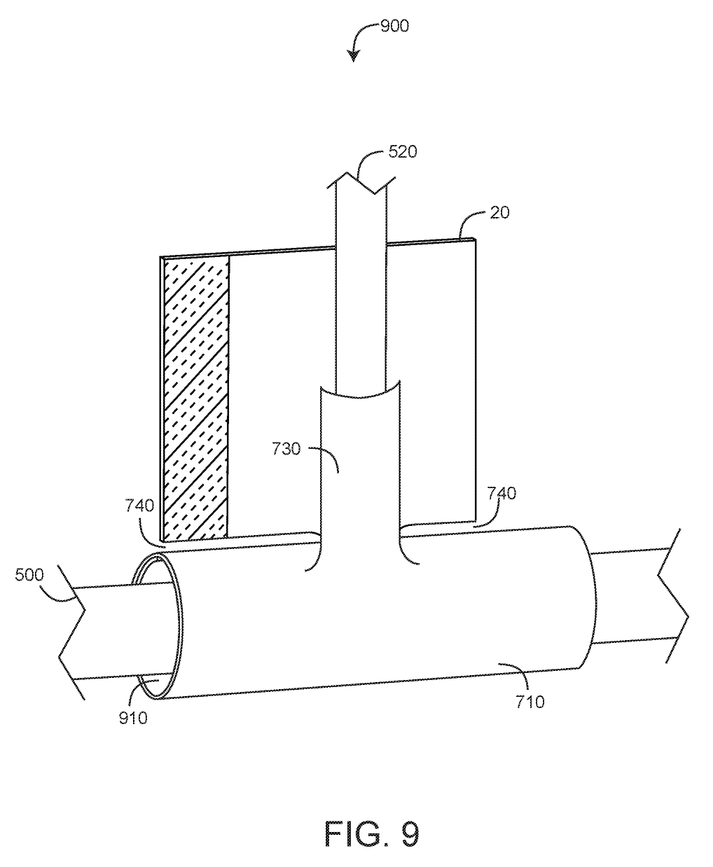

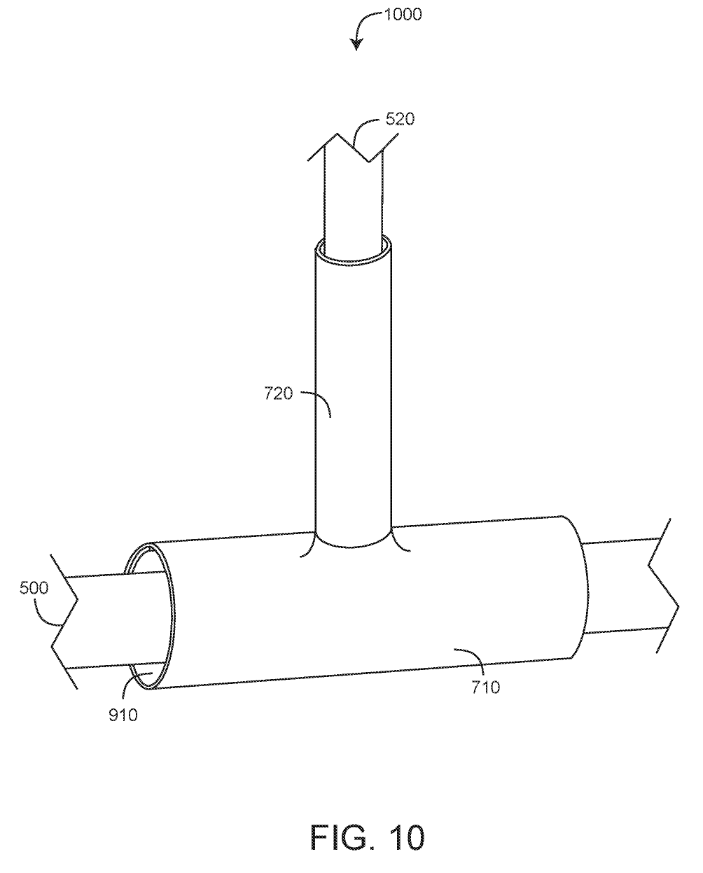

FIG. 7 illustrates the wrap-around breakout jacket 20 second embodiment in a first unwrapped position 700 having a main conduit wrap 710, a breakout conduit wrap 720 and a breakout conduit sleeve 730. The conduit wraps 710, 720 are generally square in shape, with the main conduit wrap 710 being generally larger than the breakout conduit wrap 720. A pair of elongated notches 740 define a pathway 750 between the main conduit wrap 710 and the breakout conduit wrap 720. Each of the notches 740 are generally defined by a pair of linear slits 742 terminated by a semicircular slit 734. A first end 701 of the breakout jacket 700 has two tabs 712 coated with a pressure sensitive adhesive for securing the main conduit wrap 710 in a wrapped position, as shown in FIG. 9. A second end 702 of the breakout jacket 700 has a tab 724 coated with a pressure sensitive adhesive for securing the breakout conduit wrap 720 in a wrapped position, as shown in FIG. 10. In alternative embodiments other closure mechanisms such as snaps or pressure tracks are used for securing the main conduit wrap 710 and the breakout conduit wrap 720 in wrapped positions.

Also shown in FIG. 7, an elongated sleeve 730 is disposed centrally within the main conduit wrap 710 generally aligned with the pathway 750. The sleeve 730 extends from a sleeve base 731 disposed proximate the center of the main conduit wrap 710 to a sleeve end 732 disposed between the tabs 712 and indented from the wrap first end 701. The sleeve 730 is generally defined by a pair of linear slits 737 terminated by a pair of quarter-circular slits 739. In an embodiment, the second wrap-around breakout jacket 700 is made from a heat-shrink material. Shrink direction, orientation and ratio play a major role and may be varied based on specifications for the finished product. In an embodiment, the second wrap-around breakout jacket 700 material shrinks in a lengthwise direction 790.

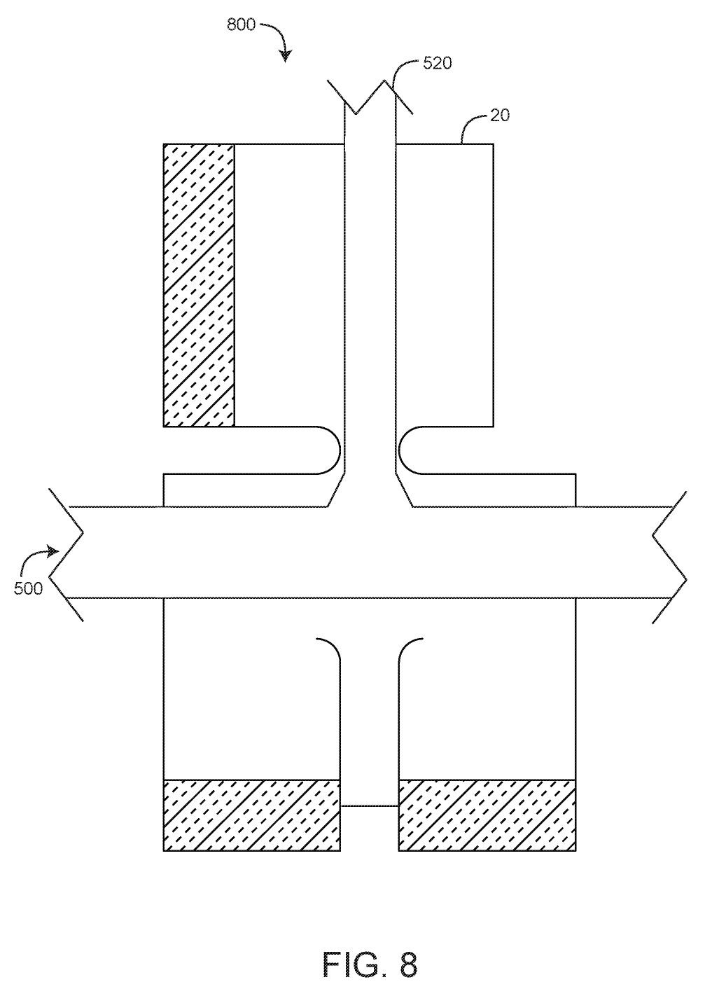

FIGS. 8-11 illustrate the detailed steps for wrapping a breakout jacket 20 around a conduit breakout installation 500. FIG. 8 illustrates the second wrap-around breakout jacket 20 embodiment in a first unwrapped position 800 fitted underneath or behind a breakout-configured conduit assembly 500 having a main conduct 510 and a breakout conduit 520.

FIG. 9 illustrates a wrap-around breakout jacket 20 in a partial wrapped position 900 with adhesive main conduit tabs 712 (FIG. 7) inserted through slots 740 (FIG. 7) and adhered to the main conduit wrap 710 so as to form a cylindrical main conduit path 910 around the main conduct 510. Further, the sleeve 730 is disposed adjacent and partially around the breakout conduit 520.

FIG. 10 illustrates a wrap-around breakout jacket 20 in a fully wrapped position 1000 with the main conduit wrap 710 disposed around the main conduit 510 and the breakout conduit wrap 720 disposed around the breakout conduit 520.

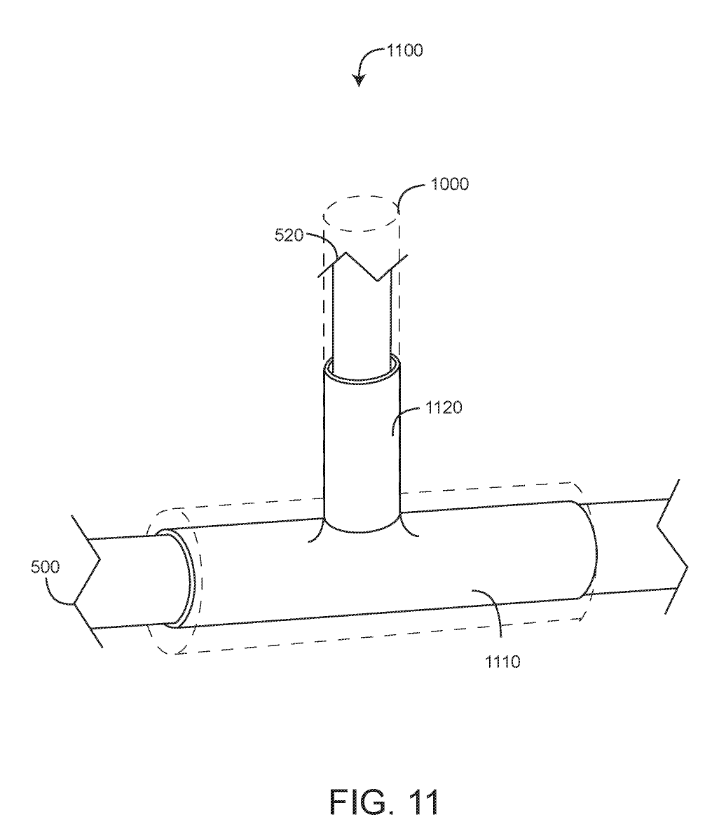

FIG. 11 illustrates a wrap-around breakout jacket 1100 in a pre-shrunk position 1101 and a post-shrunk position 1102 after heat shrinking. The shrunk main conduit wrap 1110 is tightly secure around the main conduit 510 and the shrunk breakout conduit wrap 1120 is tightly secure around the breakout conduit 520.

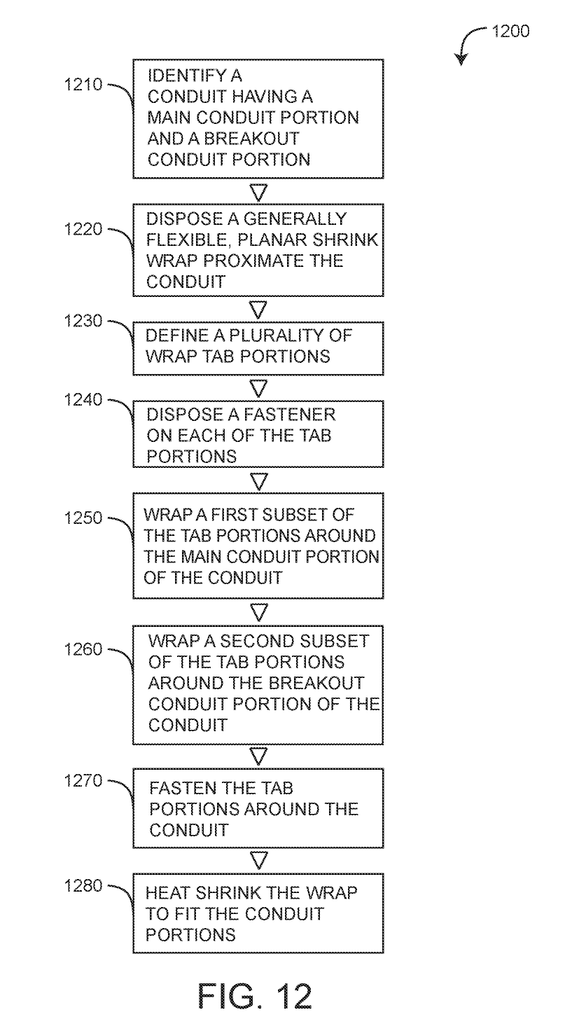

FIG. 12 generally describes a wrap-around breakout jacket 1200 system, apparatus and method. A conduit system having a main conduit and a breakout conduit is identified 1210. A generally flexible planar shrink wrap is disposed proximate the conduit system 1220. Wrap tab portions of the wrap are defined 1230. Fasteners are disposed on each of the tab portions 1240. A first subset of tabs are wrapped around the main conduit 1250. A second subset of tabs are wrapped around a breakout conduit 1260 and fastened 1270. The wrap is then heat shrunk to securely fit to and protect both the main conduit and the breakout conduit. 1280.

A wrap-around breakout jacket has been disclosed in detail in connection with various embodiments. These embodiments are disclosed by way of examples only and are not to limit the scope of the claims that follow. One of ordinary skill in art will appreciate many variations and modifications.

What is claimed is:

1. A wrap-around breakout jacket comprising:
a lay-flat apparatus defining a first section and a second section;
a plurality of fasteners disposed on the first section and the second section;
the first section is folded onto itself so as to form a main conduit portion;
the second section is folded onto itself so as to form a breakout conduit portion;
a first portion of the fasteners secure the first section in a first folded position; and
a second portion of the fasteners secure the second section in a second folded position.

2. The wrap-around breakout jacket according to claim 1 wherein:
the first section comprises a first plurality of tabs and a first plurality of tab slots; and
the tabs insert into the tab slots to form the main conduit portion.

3. The wrap-around breakout jacket according to claim 2 wherein:
the second section comprises a jacket center section disposed between a second plurality of tabs; and
the second plurality of tabs fold onto and bow the jacket center section so as to form the breakout conduit portion.

4. The wrap-around breakout jacket according to claim 1 wherein:
the first section is a generally larger square defining a plurality of main conduit wraps separated by a conduit sleeve;
the second section is a generally smaller square;
the first section and the second section are separated by a plurality of elongated notches; and
the first section and the second section fold into the elongated notches to form the main conduit portion.

5. The wrap-around breakout jacket according to claim 4 wherein:
the conduit sleeve folds onto the second section; and
the second section folds around the conduit sleeve to form the breakout conduit portion.

6. The wrap-around breakout jacket according to claim 5 wherein the fasteners are adhesive.

7. The wrap-around breakout jacket according to claim 6 wherein the main conduit section and the breakout conduit section are heat shrinkable so as to secure a main conduit disposed through the main conduit section and a breakout conduit disposed through the breakout conduit section.

8. A wrap-around breakout method comprising:
identifying a conduit having a main conduit and a breakout conduit;
disposing a generally flexible, planar wrap proximate the conduit;
defining a plurality of wrap portions;
disposing a first wrap portion around the main conduit; and
disposing a second wrap portion around the breakout conduit.

9. The wrap-around breakout method according to claim 8 further comprising disposing fasteners on each of the first wrap portion and second wrap portion.

10. The wrap-around breakout method according to claim 9 further comprising heat shrinking the first wrap portion and the second wrap portion to fit around the main conduit and the breakout conduit.
